(19) United States
(12) Patent Application Publication
(10) Pub. No.: US 2008/0032065 A1
(43) Pub. Date: Feb. 7, 2008

(54) METHODS FOR COATING ENGINE VALVES WITH PROTECTIVE COATINGS USING INFRARED RADIATION

(75) Inventors: David R. Burton, Salt Lake City, UT (US); James M. Yates, Sandy, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: High Performance Coatings, Inc., Bluffdale, UT (US)

(21) Appl. No.: 11/690,988

(22) Filed: Mar. 26, 2007

Related U.S. Application Data
(60) Provisional application No. 60/787,596, filed on Mar. 30, 2006.

(51) Int. Cl. H05B 6/00

(52) U.S. Cl. 427/595

(57) ABSTRACT

A method of manufacturing valves and other engine valves with a corrosion and heat resistant coating comprises applying a protective coating in the form of a slurry to the engine part and curing the protective coating using infrared radiation. The protective coating may include one or more of metal and/or ceramic materials, one or more of organic and/or inorganic binders, and a solvent (e.g., water or volatile organic solvent). The method may include masking a portion of the engine valve to limit the area that is coated by the protective coating. The emissivity of the protective coating is generally greater than about 0.7 in order to more effectively absorb infrared radiation during the curing process. The protective coating is typically cured by heating to a temperature of about 100° C. to about 650° C. using infrared radiation. The protective coating helps prolong the life of the valve and resists wear and breakage in locations prone to breakage.

### CROSS-REFERENCE TO RELATED APPLICATION

This application claims the benefit under 35 U.S.C. § 119 of U.S. provisional application Ser. No. 60/787,596, filed Mar. 29, 2006, the disclosure of which is incorporated herein in its entirety.

### BACKGROUND OF THE INVENTION

1. The Field of the Invention

The present invention relates to internal combustion engine parts exposed to high temperatures. More particularly, the present invention relates to engine parts coated with a high temperature coating and internal combustion engines incorporating the same.

2. Related Technology

Engine valves are subject to severe temperatures, chemicals, pressures, and wear. Eventually the wear and tear on an engine valve will cause it to fail, necessitating repair or replacement. It is well known in the art to improve the life of an engine valve by making the part out of stronger materials such as high performance alloys.

One problem with many of the high performance alloys is the cost associated with making and machining the valve. Non-corrosive metal alloys are typically very expensive to make. In addition, the hardness of many metal alloys makes them very expensive to machine. For example, nickel or cobalt alloys are often used where hardness is needed. However, nickel and cobalt alloys are so hard that they typically have to be machined using diamond coated tools.

Another approach to improving the performance and wear of engine parts is to coat the parts with a ceramic coating. Protecting engine parts using ceramic coatings is also difficult and expensive to carry out. The time and temperatures at which many ceramic coatings are applied also significantly increase the cost. For example, many ceramic coatings require a sintering step that is performed at 1600-2500 ° F. for an extended period of time. The energy required to perform the sintering step can make applying the coating cost prohibitive. Another problem with applying a ceramic coating is the need to apply the coating evenly. If the coating runs or pools, even a coating that is initially applied in an even manner can become uneven before it is baked in place.

### BRIEF SUMMARY OF THE INVENTION

The present invention relates to an improved method for applying a protective coating to internal combustion engine valves. The coatings of the present invention are applied to an engine part and then at least partially cured using infrared radiation.

The method of the present invention is generally carried out by (i) providing an engine valve (ii) preparing the engine part for coating (iii) applying a protective coating to at least a portion of the valve, and (iv) at least partially curing the protective coating using infrared radiation.

Any engine valve can be coated according to the present invention. A typical engine valve has a stem portion and a valve head. The valve head is bell shaped and has a valve seat around the outer portion of the valve head. In one embodiment, the valve seat is made from a hard cladding layer (e.g., a nickel or cobalt superalloy), and the valve head body and valve stem are made from a softer metal such as steel.

The engine valves used in the coating method of the present invention can be selected from any kind of combustion engine where valves are employed. The engine valves can be used with diesel engines, gasoline engines, flex fuel engines, alcohol burning engines, among others.

The engine valves are prepared for coating by cleaning the portion of the surface that is to be coated and/or roughening the surface to improve bonding. In an exemplary embodiment, the portion of the valve that is to be coated is roughened using grit blasting. Tooling is applied to the valve to mask a portion of the valve that will not be coated with the protective coating. For example, it may be desirable to leave the valve seat uncoated since the valve seat is typically made from a nickel or cobalt superalloy. The masked valve is then grit blasted to roughen the surface of the engine valve. Roughening the surface of the valve helps the protective coating bond to the metal.

The protective coatings of the present invention typically include the following three components: (i) a metal and/or a ceramic material, (ii) a binder, and (iii) a solvent. Examples of suitable metals and ceramic materials include silicon, zinc, zirconium, magnesium, manganese, chromium, titanium, iron, aluminum, noble metals, molybdenum, cobalt, nickel, silica, calamine, zirconia, magnesia, titania, alumina, ceria, scandia, yttria, among others. Examples of suitable binders include ethylene copolymers, polyurethanes, polyethylene oxides, various acrylics, paraffin waxes, polystyrenes, polyethylenes, celluslosics, “agar,” soda silicate, kairome clay, titania and aluminum phosphate, among others. Examples of suitable solvents include polar solvents such as water, methanol, and ethanol and non-polar organic solvents such as benzene and toluene.

The protective coating compositions are made by mixing a metal and/or metal oxide, a binder, and a solvent to form a paste or slurry. The metals, metal oxides, binders, and solvents are selected to give the coating a desired emissivity such that it will efficiently absorb infrared radiation. In a preferred embodiment, the emissivity of the coating composition is greater than about 0.7, more preferably greater than about 0.90, and most preferably greater than about 0.95.

The protective coating composition is then applied to the engine valve in the desired location. The coating can be applied using any technique that can lay down a layer of composition having a desired thickness and uniformity. Suitable methods include spray coating, spin coating, and brushing. The engine valve can be masked prior to applying the coating composition to prevent the coating from being applied to locations that are not intended to be coated. For example, it may be desirable to mask the seat face to prevent the coating composition from being applied thereto.

The coating composition is cured using infrared radiation. The infrared radiation heats the coating layer to a temperature in a range from about 100° C. to about 650° C., more preferably in a range from about 200° C. to about 550° C., and most preferably in a range from about 250° C. to about 450° C. The infrared heating bonds volatilizes and/or burns off most or all of the solvent and optionally some or all of the binder. As the solvent and binder are removed, the metal and/or ceramic materials sinter to form a protective coating that is corrosion and heat resistant. During the curing phase, the protective coating bonds to the surface of the valve thereby forming a permanent composition barrier.

Curing the coating using infrared radiation is advantageous because the coating can be cured quickly and economically. The high emissivity of the coating efficiently absorbs the infrared radiation while other parts of the valve and/or masking does not. The masking and/or non-coated portions of the valve typically have or can be made to have low emissivity such that energy is not absorbed by these areas. One reason why the coatings of the present invention cure more quickly is because infrared radiation can penetrate the surface of the coating. Thus, the coating is cured at various depths without the need to wait for conduction of the heat through the layer. This feature is also partially responsible for the ability to cure at lower temperatures. By directing the heat at the coating, the curing temperatures can be reached without heating the entire part to a high temperature. Thus, the method for coating valves according to the present invention can be carried out more economically and quickly than by using other methods.

In a preferred embodiment, the coating cures in less than about 0.5 hour, more preferably less than about 20 minutes, and most preferably in less than about 5 minutes. The ability to cure relatively quickly and/or at relatively low temperatures can dramatically reduce the energy requirements for applying the coating.

These and other advantages and features of the present invention will become more fully apparent from the following description and appended claims as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is an elevational view of an exemplary valve suitable for use with the method of the present invention;

FIG. 2 is a partially sectioned view of the valve of FIG. 1 showing a cladding layer and cladding interface;

FIG. 3 shows the valve of FIG. 1 masked for grit blasting;

FIG. 4 shows the valve of FIG. 1 with a roughened surface and masking for application of the protective coating;

FIG. 5 is an elevational view of an exemplary inlet valve having a protective coating according to the present invention; and

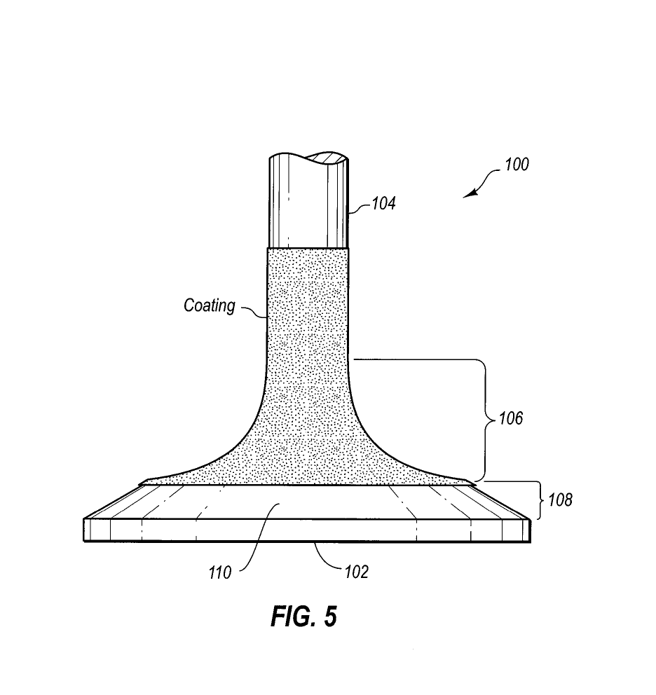

FIG. 6 is a schematic of an exemplary system for coating valves according to the present invention.

### DETAILED DESCRIPTION OF EXEMPLARY EMBODIMENTS

I. INTRODUCTION

The present invention relates to a method for coating engine valves with a protective coating using infrared radiation. The compositions used to coat the valves have a high emissivity value. The high emissivity allows the coating to be rapidly and efficiently cured using infrared radiation.

The methods of the present invention generally includes (i) providing an engine valve (ii) preparing the engine part for coating (iii) applying a protective coating to at least a portion of the valve, and (iv) at least partially curing the protective coating using infrared radiation.

II. METHODS FOR COATING ENGINE VALVES

A. Providing Valves

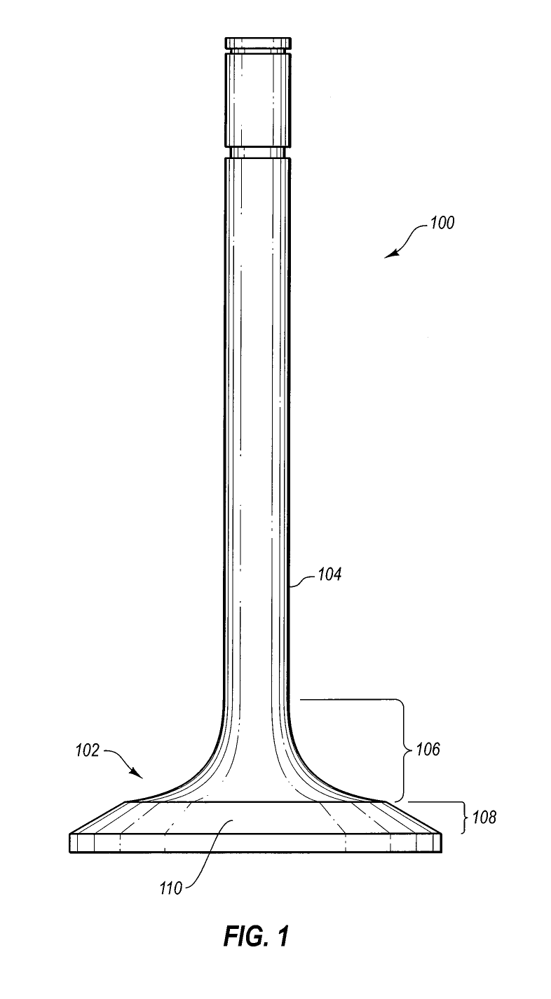

The method of the present invention can be used to apply a protective coating to any valve capable of being used in an internal combustion engine. FIG. 1 shows a typical valve 100 that can be coated according to the methods of the present invention. The body of valve 100 includes a valve head 102 and a valve stem 104. The valve head 10 has a bell region 106 and a seating face 108. A portion of the seating face 108 functions as a valve seat 110. Valve seat 110 is the portion of seating face 108 that engages the air intake or exhaust port of the engine to form a seal.

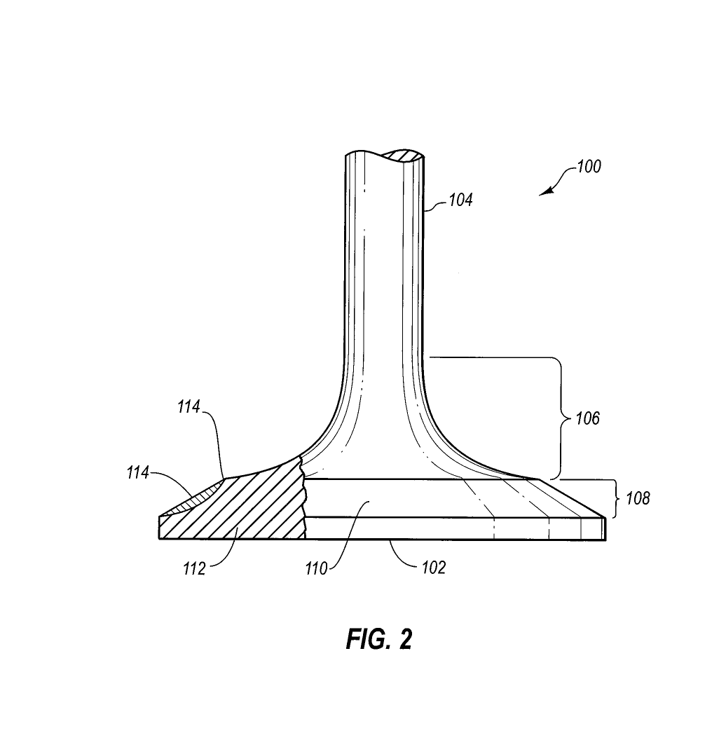

In one embodiment the valve has a valve seat material comprises a hard cladding material, typically a cobalt or nickel alloy. FIG. 2 shows the exemplary valve 100 with a portion of valve head 102 cut away to reveal the underlying structure of the valve head 102. Valve head 102 includes a valve body 112 and a cladding 114. Cladding 114 is made from a hard material suitable for use as a valve seat (e.g., Stellite). The valve seat 110 is subject to severe conditions and stress during use. Consequently, it is well known to use hard alloy materials such as cobalt or nickel alloys to improve the durability of the valve seat.

Valve body 112 is typically made for an inexpensive metal such as low carbon steel. While valve body 112 can be subject to relatively harsh operating conditions, the valve body 112 is typically not made from hard alloys due to cost.

The hard alloys of the cladding 114 and the softer metals of the valve body 112 abut one another to form a cladding-body interface 116 on the surface of valve head 102. If the valve is circular, the cladding-body interface will tend to be a curved line that is concentric with the seating face 108. However, the cladding-body interface need not be concentric with seating face 108. Furthermore, valve head 102 can have shapes other than “bell-shaped.” During use of inlet valve 100 in an internal combustion engine, cladding-body interface 116 will be situated on the inside of the port (i.e., within the air intake or exhaust) when the valve is in the closed position.

B. Components Used to Make Coating Compositions

The protective coating compositions of the present invention generally include the following three components: (i) a metal and/or a ceramic material, (ii) a binder, and (iii) a solvent.

1. Metals and Ceramic Materials

The coating compositions of the present invention include a metal oxide as a primary component and optionally metals as a secondary metallic component. In a preferred embodiment, the coatings include at least one metal oxide and at least one metal. The combination of metal oxides (i.e., ceramics) and metals can contribute to the high temperature and corrosion resistance of the cured coating and the high emissivity of the uncured coating compositions. In an exemplary embodiment, the metals and/or ceramics are provides as particulate. The particulate can be one or more sizes and can range in size from about 1 nm to about 1 mm.

A wide variety of ceramics and metals can be used in the protective coatings of the present invention. Suitable examples include silicon, zinc, zirconium, magnesium, manganese, chromium, titanium, iron, aluminum, noble metals, molybdenum, cobalt, nickel, tungsten oxides thereof, and combinations thereof. Examples of suitable oxides include silica, calamine, zirconia, magnesia, titania, alumina, ceria, scandia, yttria, among others.

2. Binders

The binders used in the coating compositions of the present invention are typically organic or inorganic materials that can bind the metals or ceramics before or during sintering (i.e., curing). Examples of suitable organic binders such as ethylene copolymers, polyurethanes, polyethylene oxides, various acrylics, paraffin waxes, polystyrenes, polyethylenes, celluslosic materials, polysaccharides, starch, proteins, “agar,” and other materials. Suitable inorganic binders include silicon based binders such as soda silicate, kairome clay, titanium based binders such as titania sol and other inorganic binders such as aluminum phosphate.

3. Solvents

Any solvent can be used to combine and/or deliver the metal and/or ceramic material so long as the solvent is compatible with the particular metals and/or ceramics and binders being used. Examples of suitable solvents include polar solvents such as water, methanol, and ethanol and non-polar organic solvents such as benzene and toluene.

C. Manufacturing Coating Compositions

The protective coating compositions are typically designed to provide a coating that can withstand temperatures and conditions within a combustion chamber, air intake, or exhaust. In an exemplary embodiment the protective coating are stable and corrosion resistant to temperatures in a range from about 300° C. to about 1000° C.

The coating compositions are made by selecting one or more metal oxides or metals, one or more binders, and one or more solvents and then mixing the components to form a paste or slurry. In an exemplary embodiment, the metal oxide is the predominant component. The metal oxide gives the protective coating heat resistance and resistance to corrosion. The metal oxide is typically included in an amount in a range from about 30 wt % to about 70 wt % of the coating composition (i.e., the uncured composition).

Metals can be included in the coating composition, typically in smaller amounts than the metal oxide. In a preferred embodiment, the amount of metal in the coating composition is in a range from about 0.5 wt % to about 20 wt %. The metals can give the coating toughness and heat resistance and help with the curing process.

The solvent is typically included in an amount that ranges from about 10 wt % to about 30 wt % of the coating composition. The solvent serves as a carrier or medium for mixing the metal oxides, metals, and binders. The consistency of the coating composition can be adjusted by adding greater or lesser amounts of solvent. If desired, the coating composition can be made into a slurry such that it can be applied by spray coating.

The metal oxides, metals, binders, and/or solvents are selected to give the uncured coating composition high emissivity. Protective coating compositions that have high emissivity can be cured at relatively low temperatures using infrared radiation. The coating composition preferentially absorbs infrared energy, thus heating up, while low emissivity uncoated portions tend to reflect the infrared energy, thereby remaining cooler. In a preferred embodiment, the coating composition has an emissivity of greater than about 0.7, more preferably greater than about 0.9, and most preferably greater than about 0.95. The emissivity of a material can depend on the temperature. For purposes of the present invention, the emissivity value is based on the emissivity of the coating composition at the curing temperature.

The emissivity of the coating composition will depend on all the components in the coating. Typically selection of the metal oxide has the most significant impact on the emissivity of the coating composition as a whole. Emissivity value for various suitable metal oxides is provided in Table 1.

TABLE 1

| Material | Temp (° C.) | Emissivity |
|---|---|---|
| 20-Ni, 24-Cr, 55-Fe, Oxidized | 500 | .97 |
| Iron, Oxidized | 499 | .84 |
| Molybdenum, Oxidized | 371 | .84 |
| Nickel Oxide | 538-1093 | .59-.86 |
| Platinum, Black | 260 | .96 |
| Titanium, Anodized onto SS | 93-316 | .96-.82 |
| Smooth Glass | 0-93 | .92-.94 |
| Fe₂O₃ | 24 | .91 |
| Al₂O₃ | 24 | .94 |
| ZnO | 24 | .95 |
| MgCO₃ | 24 | .91 |
| ZrO₂ | 24 | .95 |
| MgO | 24 | .91 |
| Glazed Silica | 1000 | .85 |

D. Preparing the Valve for Coating

Typically the engine valve is prepared in various ways before a coating composition can be applied. The surface of the engine valve is prepared to ensure good bonding between the valve and the coating. Preparing the surface typically includes cleaning and roughening the surface. In an exemplary embodiment, the surface is washed to remove lubricants and other materials that can affect bonding of the protective coating. Depending on the type of coating to be applied and the type and condition of the metal substrate, it can be advantageous to roughen the valve surface that is to be treated.

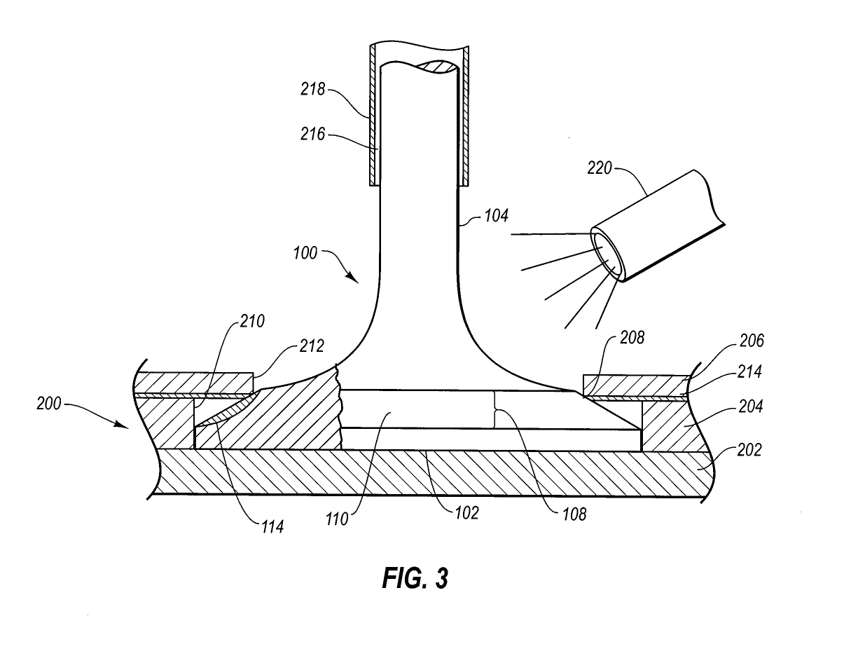

FIG. 3 shows exemplary tooling 200 that can be used to mask the valve seat 110 and a portion of the valve stem 104 of valve 100. Masking the valve seat and valve stem ensures that the valve seat 110 and valve stem 104 are not damaged during the manufacturing process.

The valve seat 110 is masked using three plates. A bottom plate 202 provides a support for valve 100 and the remaining plates. Spacer plate 204 provides spacing between bottom plate 206 and a masking plate 206. The thickness of spacer plate 204 is selected such that the bottom edge 208 of masking plate 206 is positioned on seat face 108 so as to cover valve seat 110.

Spacer plate 204 and masking plate 206 are made by precision cutting an aperture in a sheet of metal. The aperture 210 in spacer plate 204 is precision cut to fit around the outside diameter of valve head 102. The aperture 212 in masking plate 206 is precision cut to fit against the seating face 108.

In one embodiment, the plates are designed to simultaneously mask a plurality of inlet valves. In this embodiment, a plurality of apertures are cut into spacer plate 204 and a plurality of apertures are cut into masking plate 206 such that a plurality of inlet valves can be prepared from a single set of plates.

Due to the small tolerances typically needed to precisely mask the valve seat, a compressible layer 214 can be positioned between masking plate 206 and spacer plate 204. Compressible layer 214 can provide good contact between spacer plate 204 and masking plate 206 even if the aperture in masking seat 206 is slightly small thereby causing masking plate 206 to sit higher on seating face 108. Alternatively, if spacer plate 204 is slightly to thin, compressible layer 214 can provide the additional spacing to properly position masking plate 206 on seating face 108. A plurality of clamps or similar devices can be used to compress the plates. Clamping the plates can be beneficial because it provides a tight seal to prevent grit or particulate from contacting the valve seat during grit blasting or another technique used to roughen the surface.

The valve stem 104 is partially masked using a sleeve 216. Sleeve 216 is closed at one end and the length of sleeve 216 is selected such that the sleeve ends along valve stem 104 where the protective coating is to be applied. Sleeve 216 is preferably made from a soft metal such as aluminum to prevent the sleeve from scratching valve stem 104 as sleeve 216 is put on and taken off. If a soft metal is used to make sleeve 216, sleeve 216 can be coated with a layer 218 of silicon or other coating that can protect sleeve 216 against grit blasting. Coating sleeve 216 with silicon or other resilient coating can extend the life of the sleeve such that it can be reused.

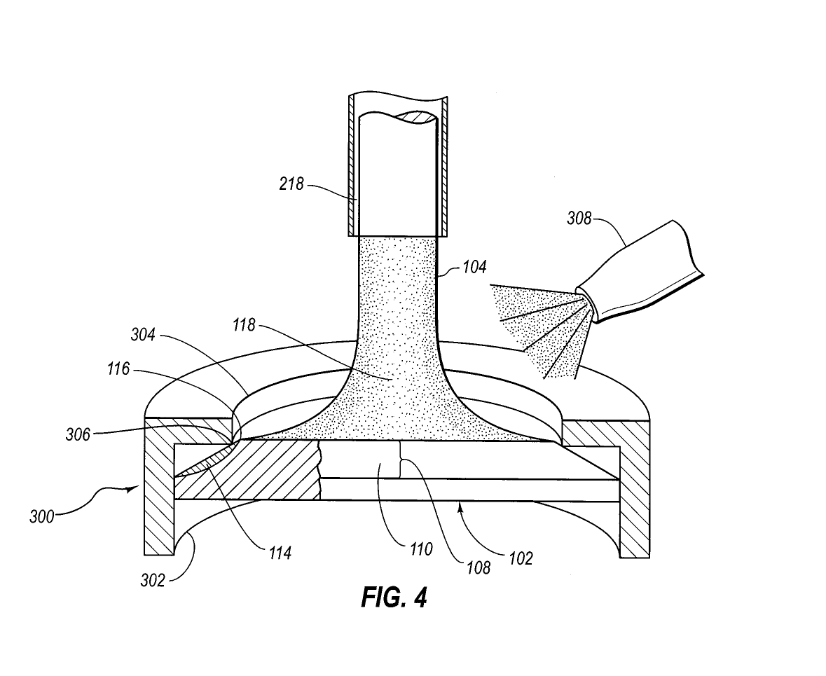

Once tooling 200 is positioned on valve 100, valve 100 is grit blasted using blasting tool 220 to roughen the surface of the unmasked portion. Equipment used to grit blast (i.e., sand blast) metals is known in the art. An example of a suitable grit is aluminum oxide. The grit size is typically in a range from about 80 grit to about 200 grit. Grit blasting is carried out for sufficient time to roughen the surface with minimal removal of material. Once grit blasting is complete, tooling 200 can be removed and valve 100 can be sprayed clean with air. Grit blasting results in a roughened area 118 (FIG. 4).

E. Applying the Coating to Engine Valve

FIG. 4 illustrates exemplary masking tooling 300 that can be used to mask valve 100 for purposes of applying the protective coating to the roughened area 118 of valve 100. Masking tooling can be a single ring having an aperture therethrough for receiving valve head 102. Masking tooling 300 has a first aperture 302 with a width that is slightly larger than the width of valve head 102 such that masking tooling 300 can be slidably received over valve head 102. A second aperture 304 is sized and configured to engage the seat face 108 so as to leave the roughened area 118 exposed. An edge 306 of masking tooling 300 engages the seating face 108 on the cladding so as to leave the cladding interface 116 exposed while covering the valve seat 110.

A portion of valve stem 104 is masked using sleeve 316. The length of sleeve 316 is selected to match the grit blasting masking, thereby leaving roughened area 118 exposed. Sleeve 316 is preferably made from a soft metal such as aluminum to avoid damaging valve stem 104.

Once tooling 300 and sleeve 316 are in place, a protective coating composition is applied to the roughened area 118. In a preferred embodiment, the uncured coating is sprayed onto roughened area 118 using spray nozzle 308. In an exemplary embodiment a single thin coating of material is applied by rotating inlet valve 300.

The coating can be any desired thickness so long as the thickness does not substantially interfere with valve movement or gas flow over the valve. In a preferred embodiment, the coating thickness is in a range from about 0.0002 inches to about 0.002 inches. The desired thickness depends on the type of coating used and the amount of material needed to provide the desired protection. Relatively thin coatings are preferred due to the decreased cost and the increased simplicity with which they can be applied.

Sleeve 316 and tooling 300 can be coated with a non-stick coating to hinder the bonding or adhesion of the protective coating composition to the tooling and sleeve. Examples of suitable non-stick coatings include polyfluorocarbons. Preventing the protective coating from adhering to the tooling and/or sleeve allows these parts to be reused for coating additional parts.

The method of the present invention provides an economic and rapid method for coating a valve with a protective coating. The protective coating of the present invention is advantageously applied over the cladding interface to prevent corrosion at the cladding interface. The tooling 200 and masking tooling 300 can be designed and machined to ensure that the cladding interface is covered with the protective coating.

While FIGS. 3 and 4 show masking for preparing and coating the cladding-body interface and the bell region of the valve, the present invention can also be used to coat other areas of a valve. For example, the present invention can be used to coat the portion of the valve that is within the combustion chamber during combustion. Protective coatings in this area of the valve can protect the valve from the wear and tear caused by combustion.

The coating can be applied using any known technique such as spray coating or brushing. Typically the amount of solvent in the coating composition is adjusted to facilitate the type of coating that is desired. For example, in a preferred embodiment the coating composition is a slurry such that the coating can be sprayed onto a valve. The thickness of the valve can be determined by controlling the rate of spraying and the duration of spraying.

F. Curing the Coating Using Infrared Radiation

The high emissivity coatings are cured using infrared radiation. The coating compositions are exposed to the infrared radiation to heat the coating composition to a temperature in a range from about 100° C. to about 650° C., more preferably in a range from about 200° C. to about 550° C., and most preferably in a range from about 250° C. to about 450° C.

In a preferred embodiment, the coating cures in less than about 0.5 hour, more preferably less than about 20 minutes, and most preferably in less than about 5 minutes. The ability to cure relatively quickly and/or at relatively low temperatures can dramatically reduce the energy requirements for applying the coating.

Any source of infrared radiation can be used so long as the intensity is sufficient to raise the temperature of the coating to the desired curing temperature. Suitable sources of infrared radiation include gas or electric powered infrared lamps. Electric powered lamps are typically preferred for their ability to reach hotter temperatures and/or better control of the temperature. Gas fired IR lamps are typically preferred for their lower cost of operation.

In one embodiment the lamps can be adjusted to cause the infrared radiation to be substantially perpendicular to the surface of the coating. Radiation that is substantially perpendicular to the absorbing surface maximizes the absorption of the emitted radiation.

Curing the protective coatings using infrared radiation can be advantageous because the coating can be cured rapidly with good uniformity. In addition, the relatively low temperatures needed to cure the high emissivity coatings minimizes the energy costs associated with curing, thereby improving the cost effectiveness of the process

II. High Throughput Coating and Curing System

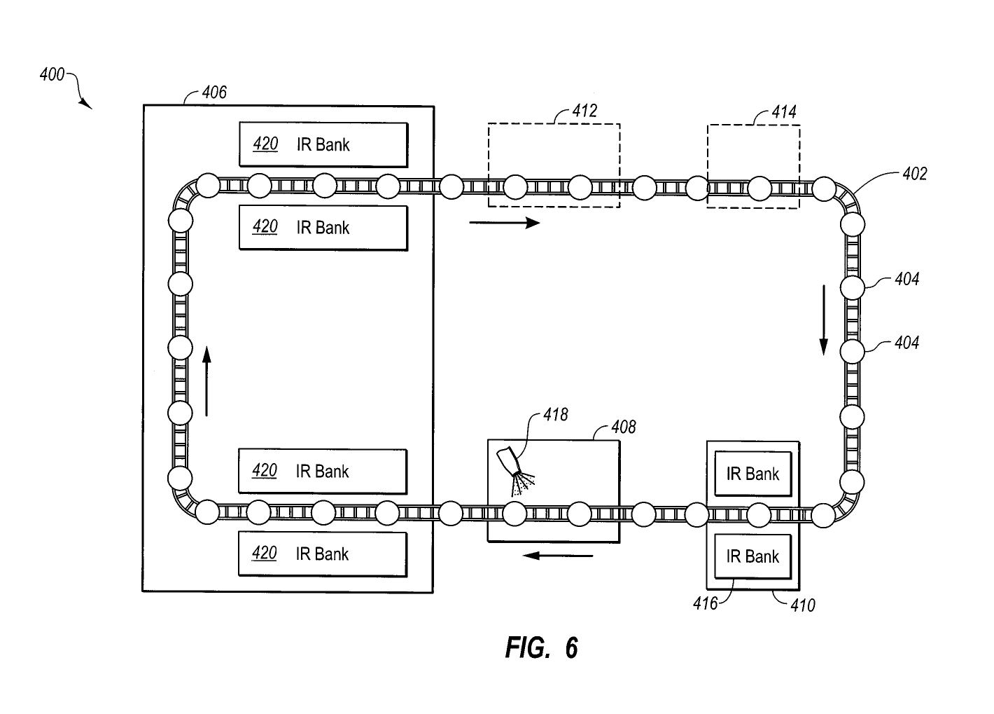

The present invention also includes a system for automating the coating and IR curing process of the present invention. As shown in FIG. 6, the system 400 generally includes an infrared oven 406, a movable track 402 that passes through oven 406, a plurality of attachment apparatuses (collectively apparatuses 404) connected to movable track 402, a spraying station 408, a preheater oven 410, a valve removal area 412, and a valve loading area 414.

The attachment apparatuses are designed to removably hold a valve. In one embodiment, the attachment apparatus includes a magnet that holds the valve onto the attachment apparatus through an attraction to the iron in the valve head. The valves can be loaded onto the attachment apparatuses 404 in the loading area 414. If masking tooling is to be used, the masking can be applied in the loading area or prior to loading the valves.

The attachment apparatuses are connected to the movable track and carried around the loop as the track moves. The track can be powered by any means, such as an electric motor. The attachment apparatus can also be made to rotate in place so as to slowly spin the valves as they travel through the spay station 408, preheater 410 and the oven 406. The spinning motion of the valves can facilitate even heating, spraying, and/or curring.

The preheater 410 includes infrared lamps 416. The preheater heats the valves before the valves are sprayed. Preheating the valves helps the curing process and can prevent the coating from running or pooling, which can result in an uneven coating.

After preheating the valves, the valves travel through the spray station 408. A sprayer 418 applies the coating composition to the valves. In a preferred embodiment, the valves are spinning in spraying station 408 such that an even coat is applied to the valves. The sprayer 418 can be hand operated by a person or automated using a robot and a computerized controller.

Once the coating has been applied to the valve, the valves travel through the oven 406 where a plurality of banks of infrared ovens 420 can be angled to apply direct radiation to the surface of the coating composition. After traveling through oven 406, the coating composition has been cured such that the protective coating is bonded to the valve and suitable for use in an internal combustion engine.

After leaving the oven, the valves can be removed in area 412. Additional valves can be loaded onto apparatuses 402 as the apparatuses enter loading area 414. The system 400 allows for rapid application and curing of the protective coating and facilitates automation to reduce costs and increase output.

The curing, spraying, and oven can be controlled to apply and even coat and cure the coating while maintaining a constant speed for movable track 402. Preferably the valves are cured in less than 10 minutes within oven 406, more preferably in less than 5 minutes and most preferably in less than about 3 minutes within oven 406.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for applying a protective coating to a valve of an internal combustion engine, comprising:
providing a valve suitable for use in an internal combustion engine;
optionally masking a portion of the valve;
providing a protective coating composition having an emissivity greater than about 0.7, the protective coating composition comprising,
one or more metal and/or ceramic materials;
one or more organic and/or inorganic binders; and
one or more solvents;
coating at least a portion of the surface of the valve with the protective coating composition; and
at least partially curing the protective coating composition by heating the coating to a temperature in a range from about 100° C. to about 650° C. using infrared radiation.

2. A method as in claim 1, wherein the emissivity value of the protective coating is at least about 0.9.

3. A method as in claim 1, wherein the emissivity value of the protective coating is at least about 0.95.

4. A method as in claim 1, wherein the protective coating is at least partially cured at a temperature in a range from about 200° C. to about 550° C.

5. A method as in claim 1, wherein the protective coating is at least partially cured at a temperature in a range from about 250° C. to about 450° C.

6. A method as in claim 1, wherein the portion of the surface of the valve that is coated is grit blasted prior to applying the coating composition thereto.

7. A method as in claim 1, wherein the portion of the surface of the valve that is coated is heated prior to applying the coating composition thereto.

8. A method as in claim 1, wherein the protective coating composition is applied as a slurry.

9. A method as in claim 8, wherein the slurry is aqueous and comprises water as a solvent.

10. A method as in claim 1, wherein the protective coating comprises at least one type of ceramic material.

11. A method as in claim 1, wherein the protective coating comprises at least one type of metal material.

12. A method as in claim 1, wherein the protective coating comprises both a ceramic material and a metal material.

13. A method as in claim 1, wherein the protective coating comprises at least one type of organic binder.

14. A method as in claim 1, wherein the protective coating comprises at least one type of inorganic binder.

15. A method as in claim 1, wherein the protective coating comprises both an organic binder and an inorganic binder.

16. A method as in claim 1, wherein the protective coating is cured in less than about 0.5 hour.

17. A method as in claim 1, wherein the protective coating is cured in less than about 20 minutes.

18. A method as in claim 1, wherein the protective coating is cured in less than about 5 minutes.

19. A method for applying a protective coating to a valve of an internal combustion engine, comprising:
providing a valve suitable for use in an internal combustion engine;
optionally masking a portion of the valve;
providing a protective coating composition having an emissivity greater than about 0.7, the protective coating composition comprising,
one or more types of ceramic materials;
one or more types of inorganic binders; and
one or more solvents;
coating at least a portion of the surface of the valve with the protective coating composition; and
at least partially curing the protective coating composition by heating the coating to a temperature in a range from about 100° C. to about 650° C. using infrared radiation.

20. A method for applying a protective coating to a valve of an internal combustion engine, comprising:
providing a valve suitable for use in an internal combustion engine;
optionally masking a portion of the valve;
providing a protective coating composition having an emissivity greater than about 0.7, the protective coating composition comprising,
one or more types of metal materials and ceramic materials;
one or more organic and/or inorganic binders; and
one or more solvents;
coating at least a portion of the surface of the valve with the protective coating composition; and
at least partially curing the protective coating composition by heating the coating to a temperature in a range from about 100° C. to about 650° C. using infrared radiation.
